(19) United States
(12) Patent Application Publication
(10) Pub. No.: US 2005/0106551 A1
(43) Pub. Date: May 19, 2005

(54) Footprint teaching aid for developing empathy

(76) Inventors: Andrea Goodman Weiner, New Hope, PA (US); Judith L. Jacobson, Gwynedd Valley, PA (US); Tammy Russeck, Doylestown, PA (US)

Correspondence Address: Wendy W. Koba, PO Box 554, Springtown, PA, 18081, US

(21) Appl. No.: 10/963,326

(22) Filed: Oct. 12, 2004

Related U.S. Application Data
(60) Provisional application No. 60/509,887, filed on Oct. 9, 2003.

(51) Int. Cl. G09B 19/00

(52) U.S. Cl. 434/397

(57) ABSTRACT

A teaching aid for assisting individuals, particularly young children, in learning and developing empathy. The teaching aid consists of a floor mat including a depiction of a pair of shoes. The shoes may be printed directly on the top surface of the mat, or the mat may be three-dimensional, with the pair of shoes slightly recessed below the surface of the mat. An individual may then literally “stand in the shoes” of someone else and begin to develop the skills leading to empathy. In the classroom setting, the shoes may be depicted as a pair of children's sneakers, with individuals taking turns standing on the mat. Other depictions may be appropriate, particularly in a counseling situation.

### CROSS-REFERENCE TO RELATED APPLICATION

The present application claims the benefit and priority of Provisional Application No. 60/509,887, filed Oct. 9, 2003.

### TECHNICAL FIELD

The present invention relates to a developmental “teaching toy” and, more particularly, to a teaching aid in the form of “footprints” for developing empathy in young children.

### BACKGROUND OF THE INVENTION

The term “emotional intelligence” was first used in 1990 by Peter Salovey and John Mayer, two psychologists interested in understanding people beyond the well-known metric of one's “intelligence quotient” (IQ). Five years later, this concept was popularized in the book Emotional Intelligence, by Daniel Goleman. Goleman defined emotional intelligence as “abilities such as being able to motivate oneself and persist in the face of frustrations; to control impulse and delay gratification, to regulate one's moods, and keep distress from swamping the ability to think, to empathize, and to hope”. Simply put, emotional intelligence is the collection of emotional qualities that guide us in how we feel, think and take action in our lives. Emotional intelligence determines how we interact with people and our own self-awareness.

As IQ is to intelligence, so “EQ” is synonymous with “emotional” intelligence. A significantly important difference between IQ and EQ is that EQ is less genetically determined. For children, this means that their EQ can be influenced to a greater extent (and thus, increased) by their parents or other caregivers, particularly since a child's brain continues to grow, particularly between the ages of three and eight. Research in brain physiology has shown that all individuals have components in the brain that comprise the “emotional brain” and the “thinking brain”. Children can learn approaches that can trigger the circuits between the emotional brain and the thinking brain, allowing these children to grow in their emotional skills. The goal of emotional intelligence is to have both brains partner together and effectively interact to enhance a child's overall well-being.

Young children, especially toddlers up through age three, are still very egocentric. The ability to think beyond themselves—“empathize”—is a difficult task and extremely hard to explain or “teach” to a youngster still exploring his/her own emotions. An empathetic person has understanding and acceptance of the feelings and actions of others. Therefore, a child who develops a sense of empathy has the ability to become a more understanding, caring friend.

### SUMMARY OF THE INVENTION

The present invention relates to a developmental “teaching aid” and, more particularly, to a teaching aid floormat in the form of “footprints” for developing empathy in young children by allowing a child to “stand in one's shoes” (hereinafter referred to as “empathy shoes”).

In accordance with the present invention, a pair of empathy shoes is formed as a multi-dimensional floor mat upon which a young child may stand and focus their thoughts and feelings in terms of literally “standing in the shoes” of someone else. In one embodiment, the empathy shoes may comprise a two-dimensional mat of a relatively pliable material (such as, for example, a plastic or foam) that may be easily transported from room to room and location to location. Alternatively, a three-dimensional floor mat may be formed, in accordance with the present invention, where the outline of the empathy shoes is recessed within the top surface of the floor mat. The floor mat may be formed to include a releasable attachment arrangement (such as, for example, hook and loop fasteners) so that different “pairs” of shoes may be attached to and removed from the floor mat. Indeed, the depiction of the shoes may vary, as needed to fulfill different learning environments. For example, in a classroom setting, the shoes may be a pair of children's sneakers, so that a child may “stand in the shoes” of one of his/her peers. In therapy situations, the depicted shoes may be those of a parent or other authority figure. Many other depictions are possible—a pair of bedroom slippers to assist in dealing with bedtime issues, ballet slippers for use with a dance class, etc.

In any of these embodiments, a pressure-sensitive playback mechanism can be included within the floormat such that when an individual stands on the mat, a phrase such as “How does it feel to be in someone else 's shoes? ” is played (thus prompting the individual to think about that question).

Indeed, the various aspects and features of the present invention are best understood by reference to the following description and the associated drawings.

### BRIEF DESCRIPTION OF THE DRAWINGS

Referring now to the drawings, where like numerals represent like parts in several views:

FIG. 1 is a top view of a two-dimensional “empathy shoes” floor mat formed in accordance with the present invention, depicting a pair of children's sneakers;

FIG. 2 illustrates a separate depiction of removable “empathy shoes” that may be attached to the floor mat of FIG. 1;

FIG. 3 is a top view of a three-dimensional “empathy shoes” floor mat formed in accordance with the present invention, depicting a pair of bedroom slippers; and

FIG. 4 is a cut-away side view of the three-dimensional floor mat of FIG. 3.

### DETAILED DESCRIPTION

The present invention, as discussed above, is directed to a teaching aid for developing empathy in a young child and, more particularly, to an educational aid in the form of a multi-dimensional floor mat outing a pair of shoes (“empathy shoes”). In accordance with the use of the inventive “empathy shoes” floor mat, a child is instructed to “stand in the shoes” of someone else by standing on the “empathy shoes” floor mat and exploring various emotions that may be felt by others in a particular situation.

FIG. 1 contains a top view of an exemplary two-dimensional implementation of the present invention, in the form of a floor mat 10 depicting a pair of shoes 12. In the embodiment as illustrated in FIG. 1, shoes 12 comprise a pair of “unisex” children's sneakers, allowing both boys and girls to feel comfortable about “standing in the shoes”. That is to say, the use of a depiction of common footwear provides a concrete teaching aid that is considered most useful in reaching the goal of teaching empathy to a young child. Floor mat 10 is preferably formed of a relatively pliable material, such as a soft plastic or foam, with shoes 12 imprinted on top surface 13 using any suitable technique. Floor mat 10 should be of a size that may be easily rolled up or otherwise packed to be transported from location to location.

Although the depiction as illustrated in FIG. 1 utilizes a pair of children's sneakers, in its broadest application any suitable pair of “shoes” may be used, and may be more appropriate for certain situations (e.g., “ballet shoes” for working with a dance class, bedtime slippers for dealing with nighttime problems). Further, floor mat 10 may include a pressure-sensitive playback mechanism 15, embedded within the footprint location, so that as an individual stands on floor mat 10, playback mechanism 15 is activated and produces a prompting statement, such as “How does it feel to be in someone else's shoes?”.

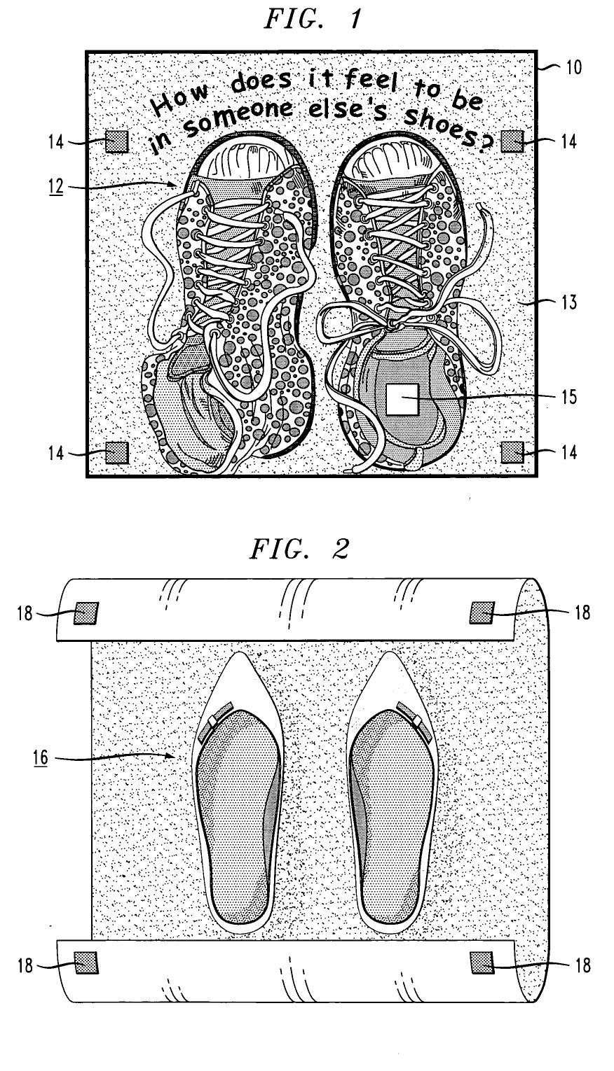

The two-dimensional floor mat of FIG. 1 may be further configured to include a releasable attachment arrangement 14 so as to allow for a different pair of shoes to be positioned on floor mat 10. FIG. 2 illustrates an alternative pair of shoes 16 (formed of the same material as floor mat 10, for example), that may be attached to floor mat 10 and used in a different leaming environment (for example, a pair of “grown-up” shoes to reflect on how a teacher would feel in a certain situation). As shown, shoes 16 include an attachment means 18 for engaging with attachment arrangement 14 to releasably fix shoes 16 over the imprinted shoes 12 of floor mat 10. In one embodiment attachment arrangement 14 and attachment means 18 may comprise a “hook and loop” arrangement. Other arrangements, such as a set of snaps, may be used to releasably attach an alternative pair of empathy shoes 16 to floor mat 10.

In an exemplary utilization, the empathy shoes floor mat of the present invention may be placed in the center of an area devoted to a group activity, such as “circle time”, where children are expected to interact and share their thoughts and/or concerns. While perhaps reading an associated children's book on the subject of emotions, a child may be selected to stand on the shoes and asked a questions such as, How do you think it feels to be in [the character's] shoes? (the question being asked by a teacher in those situations where the floor mat itself does not contain a pressure-sensitive playback mechanism). Teachers may then facilitate further discussion, or model empathetic behavior in response to the child's answer. As the story continues, the teacher may then call on other children to “stand in the shoes” of one or more story characters.

In a classroom setting, the inventive empathy shoes may be placed in a visible location and used through the day to facilitate conflict resolution or bring attention to the effects that different actions have upon one another. The inventive empathy shoes are considered to be a non-threatening tool to assist teachers/daycare providers in reconciling peer pressure among children in the classroom. As the empathy shoes become used on a regular basis, the visual cues associated with merely seeing the shoes begins to assist children in developing empathy without even going through the exercise of standing on the shoes.

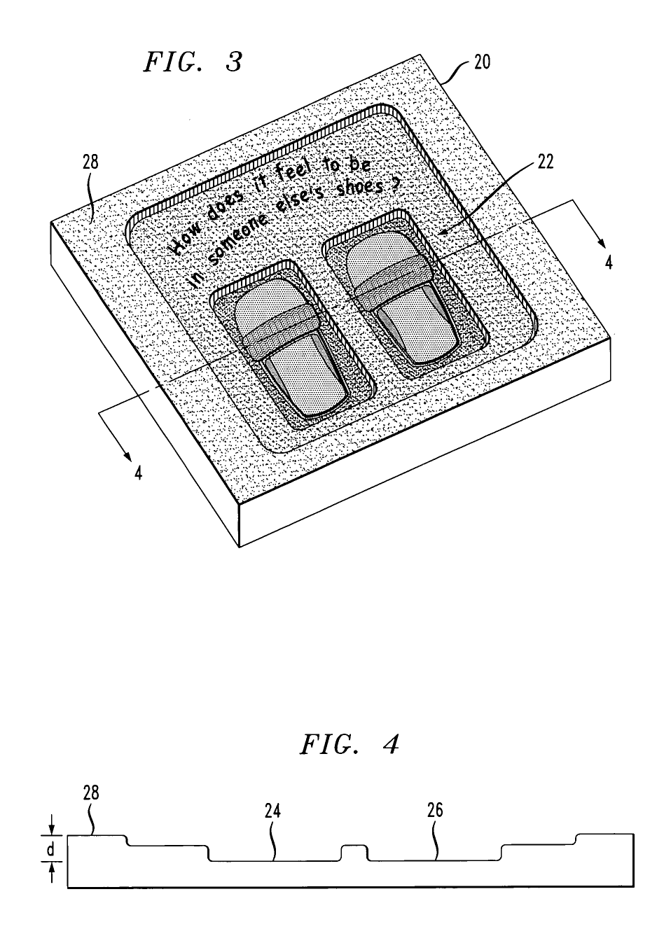

As mentioned above, an exemplary embodiment of the present invention may use a three-dimensional floor mat with the depiction of the empathy shoes recessed within the top surface of the floor mat. FIGS. 3 and 4 contain top and cut-away side views, respectively, of this particular embodiment of the present invention. Referring to both drawings, an exemplary floor mat 20 is shown as including a pair of “empathy shoes” 22 (in this case, bedroom slippers) recessed to form a pair of depressions 24 and 26 below top surface 28 of floor mat 20. Looking in particular at FIG. 4, it is shown that the depression formed may be relatively minimal, for safety reasons, with depressions 24 and 26 illustrated as having a depth d below top surface 28 of floor mat 20. It is believed that in some situations, the additional impact of actually having your feet “sink” into someone else's footprints will assist children in understanding the emotion of empathy. The particular embodiment of FIGS. 3 and 4 includes a pair of bedroom slippers, where this embodiment may be used by a therapist, parent or psychologist helping children deal with “nighttime” problems. The three-dimensional floor mat 20 may comprise a foam material, a relatively soft plastic material, or any other material suitable for use (and constant re-use) by small children.

The empathy shoes teaching aid of the present invention is considered to be useful in a number of different situations, as obvious from the above discussion, including one-on-one instruction/therapy, or in a classroom setting with a number of children. The inventive empathy shoes floor mat is considered to be an effective tool in deflecting conflicts among children by focusing their attention (and associated feelings) to the shoes themselves, thereby allowing the children to more freely express their emotions while “standing in the shoes”. Indeed, as the empathy shoes of the present invention are used, they become a visual, concrete cue for the children to stop and think about the effects of their words and actions on others, thus developing “empathy” in children at an early, impressionable age. Inasmuch as the inventive empathy shoes floor mat may be used in such a wide variety of circumstances and may depict such a wide variety of types of shoes, it is to be understood that all of these variations are considered to fall within the spirit and scope of the present invention as defined by the claims appended hereto.

1. A teaching aid for facilitating the understanding of empathy, the teaching aid comprising
a floor mat of a relatively small size and including a top surface; and
a depiction of a pair of shoes formed on the top surface of the floor mat, where an individual may stand on the depiction of the pair of shoes and “stand in the shoes of someone” to facilitate the understanding of empathy.

2. The teaching aid as defined in claim 1 wherein the floor mat comprises a relatively soft plastic material.

3. The teaching aid as defined in claim 1 wherein the floor mat comprises a foam material.

4. The teaching aid as defined in claim 1 wherein the depiction of the pair of shoes is selected to be age-appropriate for individuals using the teaching aid.

5. The teaching aid as defined in claim 4 wherein the teaching aid is for use with young children and the depiction comprises a pair of children's shoes.

6. The teaching aid as defined in claim 1 wherein the teaching aid is two-dimensional, with the depiction of the pair of shoes imprinted directly on the top surface of the floor mat.

7. The teaching aid as defined in claim 6 wherein the teaching aid further comprises releasable attachment means for attaching an alternative pair of shoes to the floor mat.

8. The teaching aid as defined in claim 7 wherein the floor mat and the alternative pair of shoes each include hook and loop attachment elements to accomplish the releasable attachment.

9. The teaching aid as defined in claim 1 wherein the teaching aid is three-dimensional, with the depiction of the pair of shoes recessed within the top surface of the floor mat.

10. The teaching aid as defined in claim 1 wherein the teaching aid further comprises a pressure-sensitive playback mechanism for announcing a prompting statement upon being stood upon.
